(19) United States
(12) Patent Application Publication
(10) Pub. No.: US 2025/0053923 A1
(43) Pub. Date: Feb. 13, 2025

(54) LEARNED SCHEDULING OF AUTONOMOUS ACTIONS BASED ON COLLABORATIVE CONVERSATIONS

(71) Applicant: INTERNATIONAL BUSINESS MACHINES CORPORATION, Armonk, NY (US)

(72) Inventors: Prerna Agarwal, New Delhi (IN); Sampath Dechu, Acton, MA (US); Jayachandu Bandlamudi, Guntur (IN); Manideep Parbat, Kolkata (IN); Sudarshan Prasad, Kolkata (IN); Mohammad Zubair, Bangalore (IN)

(21) Appl. No.: 18/447,923

(22) Filed: Aug. 10, 2023

(51) Int. Cl. G06Q 10/101; G06F 8/20

(52) U.S. Cl. CPC G06Q 10/101; G06F 8/20

(57) ABSTRACT

Learned scheduling of autonomous actions includes generating groups of action executions that execute on a collaboration platform. The groups of action executions are generated by natural language processing of contextual information extracted from one or more Chat Operations conversations. Recommendation candidates corresponding to the action executions are generated by clustering action executions contained in each of the groups. The action executions are clustered based on times of past executions. A leaned schedule is generated by ranking the recommendation candidates based on the contextual information. As generated, the learned schedule indicates one or more recommendations to execute a specific action within a specific time.

### BACKGROUND

This disclosure relates to software development and Information Technology (IT) operations, and more particularly, to automated scheduling of autonomous actions on a collaboration platform.

Chat Operations (ChatOps) is a component of software Development Operations (DevOps) and IT operations (ITOps). By combining chat clients and real-time chat tools, ChatOps facilitates DevOps and ITOps. Sometimes referred to as “conversation-driven DevOps” or “conversation-driven collaboration,” ChatOps is capable of providing members of DevOps teams and ITOps teams with efficient instant messaging and other collaboration tools. Using ChatOps, members can initiate computer-implemented actions using natural language commands. ChatOps-initiated actions may execute as background applications (apps) via application programming interfaces (APIs) to optimize the DevOps and ITOps. Increasingly, the communication and collaboration features of ChatOps are integrated with artificial intelligence (AI) to further facilitate ITOps and DevOps.

### SUMMARY

In one or more embodiments, a method includes generating groups of action executions that execute on a collaboration platform. The groups of action executions are generated by natural language processing of contextual information extracted from one or more Chat Operations conversations. The method includes generating recommendation candidates corresponding to the action executions by the clustering of action executions contained in each of the groups. Clustering is based on times of past executions of the action executions. The method includes generating a learned schedule by ranking the recommendation candidates based on the contextual information. The learned schedule indicates one or more recommendations to execute a specific action at a predetermined time.

The foregoing and other implementations can each optionally include one or more of the following features, alone or in combination. Some example embodiments include all of the following features in combination.

In one aspect, the learned schedule is one of multiple learned schedules, and the action executions execute on multiple channels of the collaboration platform. The method may include generating an aggregate ranking of the multiple learned schedules and determining, based on the aggregate ranking, an assignment of one or more of the multiple learned schedules to one or more of the multiple channels.

In another aspect, the learned schedule is one of multiple learned schedules, and the contextual information is determined by processing ChatOps conversations of multiple users of the collaboration platform. The method may include generating an aggregate ranking of the multiple learned schedules and determining, based on the aggregate ranking, an assignment of one or more of the multiple learned schedules to one or more of the multiple users.

In another aspect, the action executions may execute on multiple channels of the collaboration platform. The clustering can include generating a dependency graph based on ChatOps contextual information for each action execution on each of the multiple channels. A dependency order may be determined for each of the action executions in accordance with the clustering based on times of past executions. The recommendation candidates may be ranked based on the dependency order of each action.

In another aspect, the method can include monitoring whether action executions occur at times corresponding to the learned schedule and automatically initiating execution of an action in response to determining that a user failed to execute the action in accordance with the learned schedule.

In another aspect, the action executions can be tail executions and the learned schedule a schedule of service level agreement (SLA) alerts. The method can include generating an SLA alert in response to detecting a failure to perform a corresponding action.

In another aspect, the method can include generating groups of action executions by correlating one or more Chat Operations conversations with action executions based on identifying a user intent through natural language processing of the one or more Chat Operations conversations.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of an autonomous action learned scheduling (AALS) framework.

FIG. 2 illustrates an example method of operation of the AALS framework illustrated in FIG. 1.

FIGS. 3A and 3B illustrate certain operative features of the AALS framework illustrated in FIG. 1 and FIG. 2.

FIG. 4 illustrates an example method of operation of the AALS framework illustrated in FIG. 1.

FIG. 5 illustrates an example method of operation of the AALS framework illustrated in FIG. 1.

FIG. 6 illustrates an example method of operation of the AALS framework illustrated in FIG. 1.

FIGS. 7A and 7B illustrate example methods of operation by the AALS framework illustrated in FIG. 1.

FIGS. 8A and 8B illustrate certain operative features of the AALS framework illustrated in FIG. 1.

FIG. 9 illustrates an example of a computing environment that is capable of implementing the example AALS framework of FIG. 1.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to DevOps (Development Operations) and ITOps (Information Technology Operations), and more particularly, to automated scheduling of autonomous actions on a collaboration platform. Increasingly, collaboration platforms provide a ChatOps (Chat Operations) environment that typically utilizes several different tools. The tools may include a chat client, pre-existing DevOps tools, and a notification system. Within the ChatOps environment, the chat client serves as the primary communication channel and executes pre-programed commands over one or more other channels.

Notwithstanding the benefits provided by a collaboration platform, there remains no thoroughly effective mechanism to ensure that the collaboration platform's resources are used efficiently. It may happen, for example, that a user engaged in DevOPs or ITOps on the collaboration platform activates certain resources but fails to timely release one or more of the resources when no longer in use. The failure deprives other users of the resources. If access to a resource is granted but not timely revoked, then security surrounding the resource may be breached while the resource is no longer under the control of an authorized user.

In accordance with the inventive arrangements disclosed herein, methods, systems, and computer program products are provided that are capable of generating learned schedules of action executions on a collaboration platform. The scheduling may enhance utilization of the hardware and software resources of the collaboration platform. The inventive arrangements may prevent hardware resources being wasted maintaining collaborative tools in a state of idle when the tools are not needed. Software resources (e.g., virtual machines, clusters) are likewise prevented by the inventive arrangements from being left idle whenever not actively in use. Specifically, the learned schedules, in accordance with the inventive arrangements, may generate a notification to a user at an appropriate time to release a resource. If not released by the user according to the learned schedule, the inventive arrangements optionally may automatically release a resource at the scheduled time.

An aspect of generating learned schedules is the inventive arrangements' use of machine learning to determine when certain users on one or more collaboration platform channels repeatedly execute certain processing actions. In certain embodiments, a machine learning model trained using supervised learning identifies action executions based on contextual information extracted through processing ChatOps conversation logs associated with the collaboration platform. Action executions are clustered by the inventive arrangements based on the timing of the executions. Action executions may be ranked to generate learned schedules that more optimally schedule the timing of future executions. According to a learned schedule, the inventive arrangements generate user recommendations and, optionally, respond automatically if a user fails to heed a notification.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

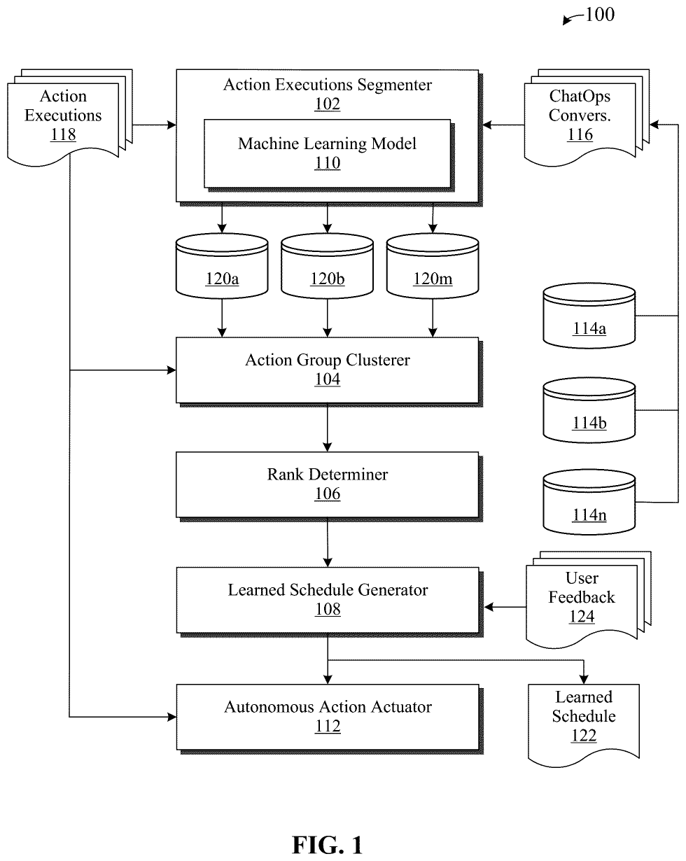

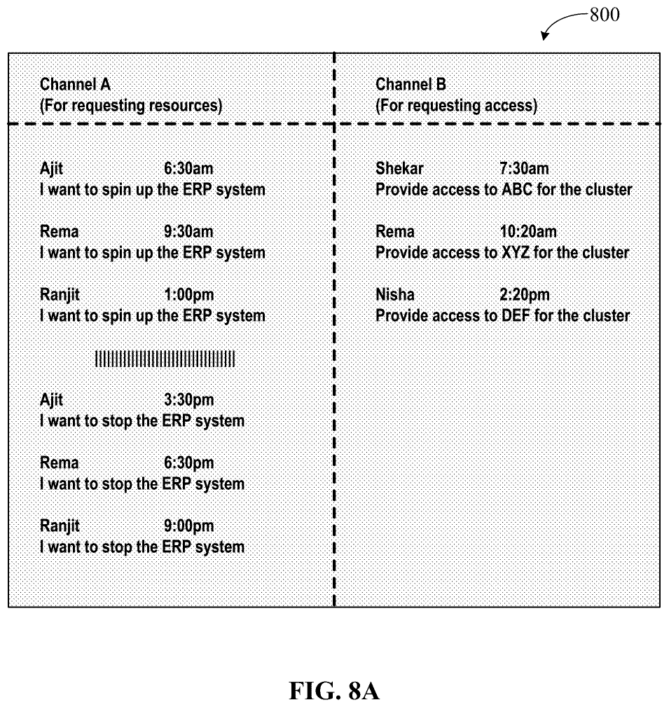

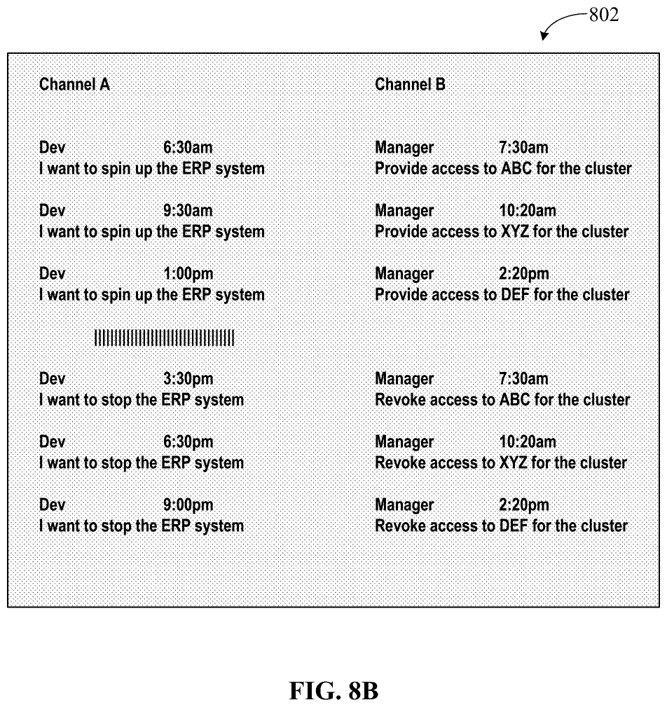

FIG. 1 illustrates an example architecture of an autonomous action learned scheduling (AALS) framework 100. AALS framework 100 may be implemented in software that is executable on the hardware of a computer such as computer 801 operating in computing environment 800, as described in reference to FIG. 8. Operatively, AALS framework 100 generates groups of action executions corresponding to different actions that execute on a collaboration platform. AALS framework 100 generates recommendation candidates corresponding to the action executions, and generates learned schedules based on rankings of the recommendation candidates. A learned schedule indicates a time for executing one or more of the actions. In certain embodiments, the learned schedule optionally may be modified in response to user feedback. Optionally, in certain embodiments, AALS framework 100 automatically executes an action in response to a user's failure to do so at the recommended time.

In the example architecture of FIG. 1, AALS framework 100 illustratively includes action executions segmenter 102, action group clusterer 104, rank determiner 106, and learned schedule generator 108. Action executions segmenter 102 implements machine learning model 110 for performing natural language processing as described below. AALS framework 100, in certain embodiments, also optionally include autonomous action actuator 112.

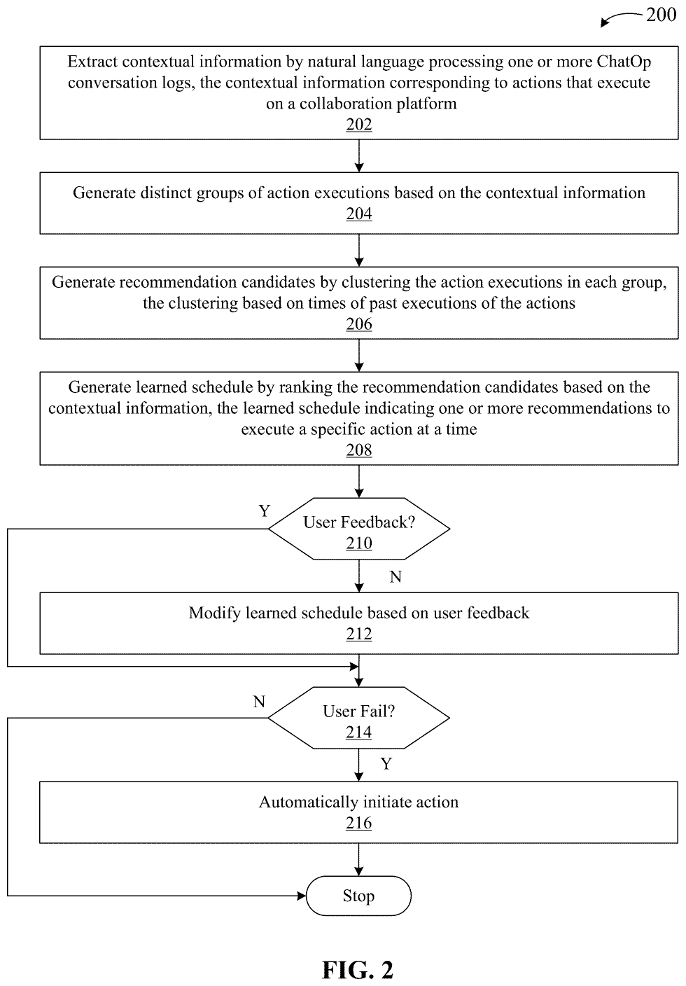

FIG. 2 illustrates an example method 200 of operation of the AALS framework 100 of FIG. 1. Referring to FIGS. 1 and 2 collectively, in block 202, action executions segmenter 102 extracts contextual information from one or more ChatOps conversations logs 114a, 114b, and 114n, each comprising ChatOps conversations. In various arrangements, action executions segmenter 102 may process fewer or more ChatOps conversations logs than those shown.

By processing ChatOps conversations logs 114a, 114b, and 114n, action executions segmenter 102 identifies ChatOps conversations 116, from which action executions segmenter 102 extracts contextual information. ChatOps conversations 116 comprise natural language used by team members during collaboration on a project (e.g., DevOps or ITOps). ChatOps conversations 116 are natural language inputs that initiate action executions 118. For example, ChatOps conversations 116 may include a natural language text input such as “spin up a VM” or “instantiate a shift cluster” or “terminate access to the ERP system.” Because ChatOp conversations 116 comprise natural language, different ordinary human expressions may be used to initiate the identical action execution. Action executions 118 comprise various types of processor-executable actions invoked by ChatOps conversations 116. As invoked by ChatOps conversations 116, action executions 118 access, control, utilize, release, and/or other otherwise manage collaboration platform resources (e.g., virtual machines, collaboration tools, clusters). Action executions 118, for example, may instantiate collaboration tools and give users access to collaboration resources, well as manage security and user rights to the resources.

ChatOps conversations 116 thus may correspond to one or more different users. ChatOps conversations 116, alternatively or additionally, may correspond to one or more channels. “Channel,” as used herein, means a collaborative chat-based application group created for a particular purpose. A channel may provide chat-based interactivity between work on a specific task or project and one or more users engaging in the task or project.

In block 204, action executions segmenter 102 segments action executions 118 into distinct groups that illustratively include groups 120a, 120b, and 120m. In various arrangements, action executions segmenter 102 may segment action executions 118 into fewer or more groups than those shown. Action executions 118 are actions previously executed on a collaboration platform using the tools of the collaboration platform. Action executions segmenter 102 groups action executions 118 based on the contextual information extracted from ChatOps conversations 116. “Contextual information,” as defined herein, is information that indicates the specific type of each of the action executions 118 and identifies the specific collaboration resource affected by each execution of the action(s). For example, the type of the action is the executable operation and object on which the operation is performed. Thus, based on contextual information extracted from ChatOps 116, action executions segmenter 102 identifies the type of each of action executions 118 and segments each of action executions 118 into one of distinct groups 120a, 120b, or 120m based on the specific type of action.

Action executions segmenter 102 groups action executions 118 by natural language processing of the contextual information extracted from ChatOps conversations 116. The natural language processing may be performed using machine learning model 110. In certain embodiments, machine learning model 110 is a logistic regression model or Support Vector Machine trained to recognize or classify user intent from ChatOps conversations 116. Machine learning model 110 in other embodiments is a deep learning neural network trained to recognize or classify user intent from ChatOps conversations 116. In still other embodiments, machine learning model 110 can implement a generative pre-trained transformer for recognizing or classifying user intent from ChatOps conversations 116.

Irrespective of the specific model implemented as machine learning model 110, action execution segmenter 102, based on recognizing or classifying user intent, maps different ChatOps conversations 116 to distinct Application Programming Interfaces (APIs) and/or other processor commands executable, for example, by one or more Chatbots of the collaboration platform. The APIs and/or other processor-executable commands initiate action executions 118, which as described above access, control, utilize, release, and/or other otherwise manage collaboration platform resources such as virtual machines, clusters, collaboration tools, applications, and the like. Thus, in accordance with certain embodiments, the APIs are commands executed in response to action execution segmenter 102's inferring the user intent from ChatOps conversations 116, and accordingly, action executions 118 may provide a record of the operations performed as a consequence of the executions of the commands.

In block 206, action group clusterer 104 generates recommendation candidates. Action group cluster 104 generates the recommendation candidates by clustering action executions 118 contained in each of distinct groups 120a, 120b, and 120m. The clustering is based on the timing of the execution of action executions 118. For example, a user on one day may spin up a virtual machine (VM) at 9:00 AM and stop the VM at 5:00 PM. On another day, the user may spin up the virtual machine at 9:30 and stop the VM at 4:30 PM. The user, on yet another day, may not spin up the VM until 3:30 PM but may not stop the VM until 12:30 AM the next day. By clustering the start times and the stop times, action group clusterer 104 predicts an average eight-hour duration between the spin up and stopping of the VM. The illustrative cluster includes three pairs of start-and-stop actions. The time intervals between starting and stopping the VM are, respectively, eight hours, seven hours, and nine hours. By averaging the duration between each pair of start and stop action executions, action group clusterer 104 generates a recommendation candidate of eight-hours between starting and stopping the VM. As described below, the recommendation candidate can correspond to a specific user and/or a specific channel implemented on the collaboration platform.

Clustering by action group clusterer 104 thus groups similar types of actions based on temporal proximity of the execution of the actions. For example, there may be three action executions related to the spinning up of an ERP machine and two action executions requesting access to the ERP machine that is spun up. Action group cluster 104 groups the three action executions of spinning up the ERP machine only if the action executions, as determined from ChatOps conversations 116, occurred within a predetermined time interval. The temporal-based clustering of actions can include the pairing of related operations. For example, based on pairing the start cluster of a specific resource (e.g., VM) with the end cluster of the same resource, action group clusterer 104 may determine the time duration that the resource is in use. Thus, while action group clusterer 104 generates clusters based on a context of the action performed, action group clusterer 104 also may pair the clusters based on the specific resource affected by the action. That is, action group clusterer 104 may pair, for example, the start and end clusters related to a VM, an application, or other collaboration platform.

In block 208, rank determiner 106 ranks recommendation candidates generated by action group cluster 104, and based on the rankings, learned schedule generator 108 generates learned schedule 122. In certain embodiments, rank determiner 106 ranks the recommendation candidates based on a count of the number of occurrences within a predetermined timeframe, or frequency, that the action corresponding to a recommendation candidate executes. Thus, the greater the frequency of occurrence of an action execution, the higher the rank of the recommendation candidate corresponding to the action.

Rank determiner 106 may in some instances avoid conflicts that may arise whenever two or more recommendation candidates conflict with one another. For example, assuming a certain user or channel, on some days a VM is spun up at 9:15 AM. On other days, however, a certain cluster is accessed at the same time. Rank determiner 106 may determine that on the majority of days the VM is spun up at 9:15 and rank that action execution a higher candidate recommendation. Thus, the action execution that occurs more times than one or more other types of action executions ranks higher, even if all occur at the same time on different days. An action that occurs more frequently within the same predetermined time interval than another action does, represents the higher-ranked recommendation candidate.

Learned schedule generator 108 optionally generates and conveys to a user a notification of learned schedule 122. Learned schedule generator 108 may accept within a predetermined time interval following generation of learned schedule 122 user feedback. If in block 210 user feedback 124 is received, then learned schedule generator 108 modifies learned schedule 122 based on the user feedback 124 received in block 212. For example, in connection with the earlier example of stopping a VM eight hours after starting, the user may modify a recommendation to stop the VM by specifying a longer or shorter time duration.

Optionally, AALS framework 100 also includes autonomous action actuator 112. Learned schedule 122 includes event-triggered recommendations. For example, the spinning up of the VM triggers a recommendation eight hours later recommending the user stop the VM. In block 214, AALS framework 100 is configured to monitor whether the user follows the recommendation at the specified time. If in block 214, autonomous action actuator 112 determines the user failed to initiate execution of a recommended action at a specified time, then in block 216 autonomous action actuator 112 automatically initiates the recommended action. For example, autonomous action actuator 112 issues an executable command that initiates the collaboration platform's stopping the VM that was spun up eight hours earlier.

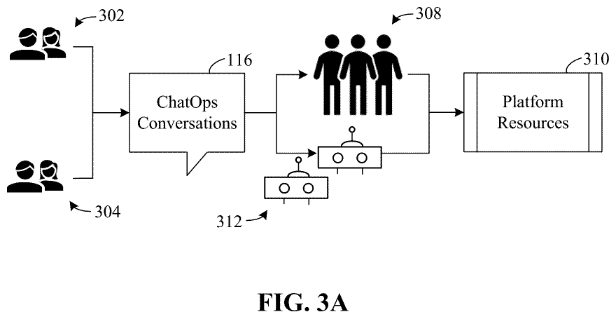

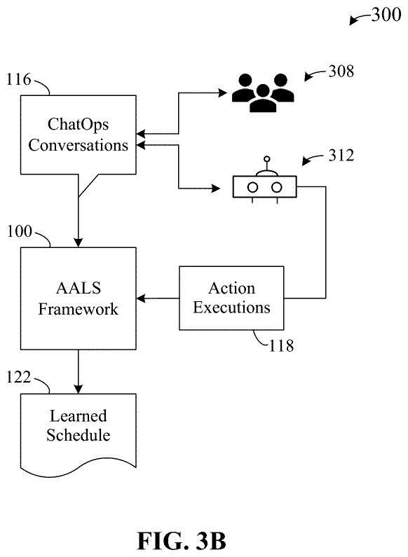

FIGS. 3A and 3B illustrate certain operative features of the AALS framework 100 in the context of a collaborative environment 300 in which multiple users 302 and 304 collaborate over multiple channels of a collaboration platform. In FIG. 3A, users 302 and 304, though located at different geographic locations, collaborate on DevOPs though the use of ChatOps conversations 116. Operating as part of one or more collaborative teams 308, users 302 and 304 access and utilize computing resources 310 of the collaboration platform through ChatOps conversations 116 with Chatbots 312. In FIG. 3B, AALS framework 100, as described above, generates learned schedule 122 based on the received ChatOps conversations 116 and action executions 118.

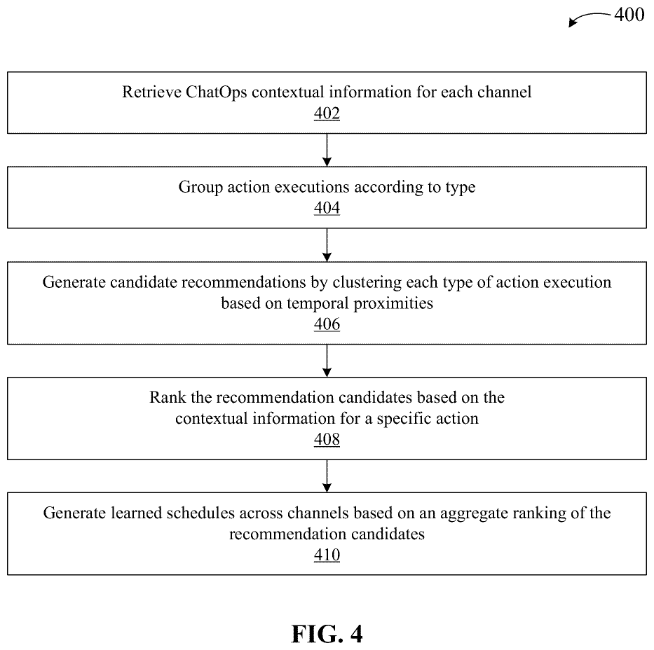

FIG. 4 is an example method 400 of generating a learned schedule for each of multiple channels implemented on a collaboration platform. Method 400 may be performed by a system implemented with the example architecture of AALS framework 100 of FIG. 1, which is capable of performing a method such as method 200 for generating a learned schedule as illustrated in block 208.

In block 402, the system obtains ChatOps contextual information for each channel (e.g., on a per channel basis). The system, in block 404, groups action executions according to the type of action executed. In block 406, the system generates candidate recommendations by clustering each type of action execution based on temporal proximities of the executions of each type of action. The system, in block 408, ranks recommendation candidates corresponding to the action executions, each recommendation based on the contextual information corresponding to the specific action. In block 410, the system generates learned schedules across each of the channels based on an aggregate ranking of the recommendation candidates. The aggregate ranking determines whether learned schedules generated for each individual channel are aggregated to create a single, composite learned schedule that applies across all the individual channels.

In certain embodiments, the aggregate ranking is determined based on a final ranking of each of the recommendation candidates. The final rankings may be determined using a machine learning model trained to weight each recommendation candidate in accordance with the recommendation candidate's importance with respect to a specific channel. In some embodiments, the machine learning model is a regression equation trained through supervised learning to weight each recommendation candidate in accordance with the recommendation candidate's importance.

A collaboration platform channel typically comprises a chat-based collaborative group of multiple users. Often, however, not every one of the users collaborating on a particular channel is interested in or involved with every type of action that executes on the channel. For example, a user that does not work on ERP systems, does not need notifications regarding ERP systems. Recommendations pertaining to ERP systems, at least for that user, are only noise. Thus, whereas method 400 pertains to learned schedules specific to channels irrespective of the users, AALS framework 100 can additionally or alternatively generate user-specific learned schedules.

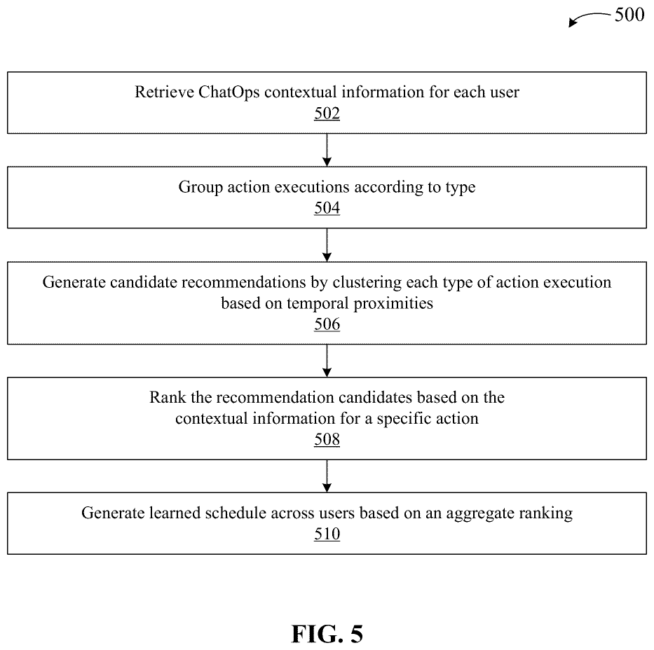

FIG. 5 is an example method 500 of generating user-specific learned schedules. Method 500 can provide a distinct learned schedule for each user who collaborates with other users using the tools and resources of a collaboration platform irrespective of the specific channels each user is associated with. Method 500 also may be performed by a system implemented with the example architecture of AALS framework 100 of FIG. 1.

In block 502, the system obtains ChatOps contextual information for each user (e.g., on a per-user basis). The system, in block 504, groups action executions according to the type of action executed. In block 506, the system generates candidate recommendations by clustering each type of action execution based on temporal proximities of the executions of each type of action. The system, in block 508, ranks recommendation candidates corresponding to the action executions, each recommendation based on the contextual information corresponding to the specific action. In block 510, the system generates learned schedules for each of the collaboration platform users based on an aggregate ranking of the recommendation candidates. The aggregate ranking determines whether learned schedules generated for each individual user is aggregated to create a single, composite learned schedule that applies across all the individual users irrespective of the specific channels each is associated with.

In certain embodiments, the aggregate ranking is determined based on a final ranking of each of the recommendation candidates. The final rankings may be determined using a machine learning model trained to weight each recommendation candidate in accordance with the recommendation candidate's importance with respect to a specific user. In some embodiments, the machine learning model is, again, a regression equation trained through supervised learning to weight each recommendation candidate in accordance with the recommendation candidate's importance to the specific user.

The ranking of each recommendation candidate can be based on various factors of importance. The factors may include, for example, the cost associated with a collaboration platform resource. Thus, in certain arrangements, the higher the cost associated with a resource the higher the ranking of a recommendation candidate for scheduling actions to manage the resource (e.g., to ensure the resource does not remain in an active state when no longer in use). The factors, for example, may include the availability of, or the load associated with, a resource. For example, a recommendation candidate for scheduling the shutdown of a resource may be ranked higher the greater the expected number of users of the resource. That is, if based on historical patterns, some users at a given time are expected to no longer need use of an intensively used resources, then it is all the more important to schedule a reminder for those users to release control to other users at the given time. Another factor of importance is, for example, the level of security applied with respect to the resource affected by the recommendation candidate. These and other factors, in various combination, are input to rank determiner 106 for ranking the recommendation candidates.

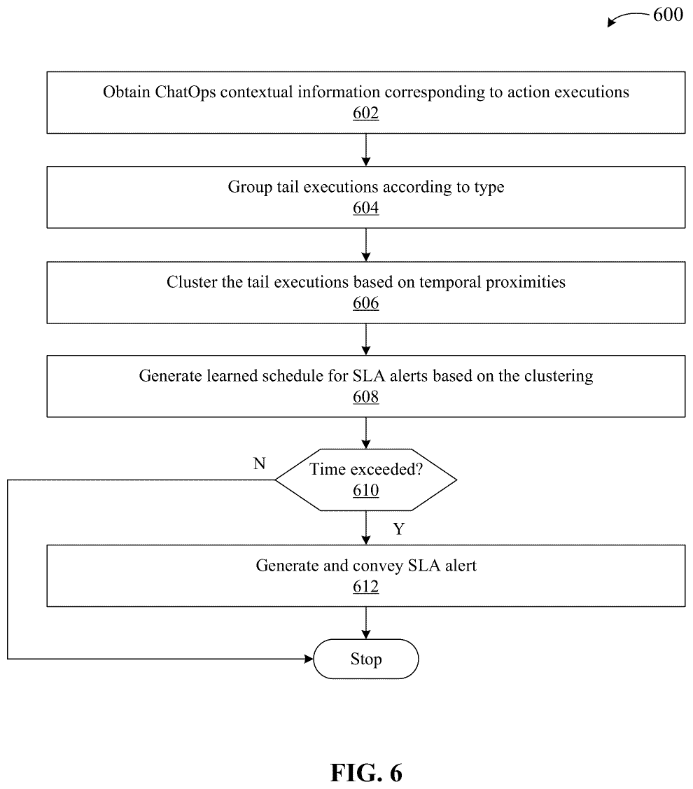

FIG. 6 is an example method 600 of generating one or more service level agreement (SLA) alerts in accordance with a learned schedule. The alerts are generated to remind one or more users using the tools and resources of a collaboration platform to take any action needed to ensure that a computing system covered by the SLA is maintained in accordance with the terms of the SLA. The users may comprise an ITOps team of one entity tasked with maintaining the SLA-covered computing system (e.g., ERP system) on behalf of another entity. Method 600 also may be performed by a system implemented with the example architecture of AALS framework 100 of FIG. 1.

In block 602, the system obtains ChatOps contextual information corresponding to action executions, the action executions performed in maintaining the SLA-covered computing system. The system, in block 604, groups tail executions of the corresponding action executions according to the type of action. As defined herein, a “tail execution” is the last of a sequence of related actions that are executed in performing an identifiable processing task. For example, a tail execution may be a subroutine performed as the final action (e.g., call) of a procedure. In block 606, the system clusters the tail executions of each group based on the temporal proximity of the respective executions (e.g., indicated by timestamps). The system thus learns from the ChatOps contextual information action executions needed to maintain the SLA-covered computing system, and from the clustering, the system learns the times that the action executions ordinarily occur.

In response thereto, in block 608, the system generates a learned schedule of SLA alerts. In block 610, the system determines whether an action execution has been performed within a predetermined time interval around the scheduled time for execution an action maintaining the SLA-covered computing system in accordance with the SLA. If an action execution has not occurred within the time interval, then in block 612, the system generates an SLA alert notifying one or more members of the ITOps that the scheduled action execution has not occurred in accordance with the learned schedule. The SLA alerts reduce the likelihood that the ITOps team fails to timely initiate an action execution that is needed to properly maintain the operability of the SLA-covered computer system.

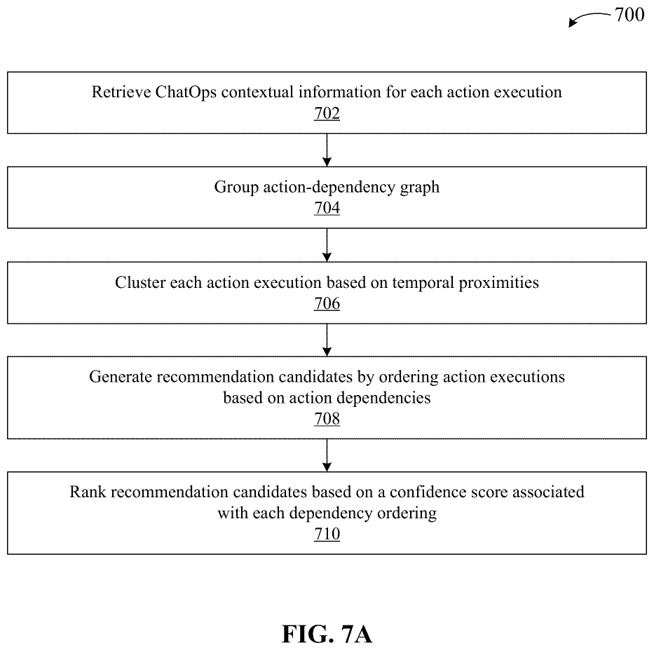

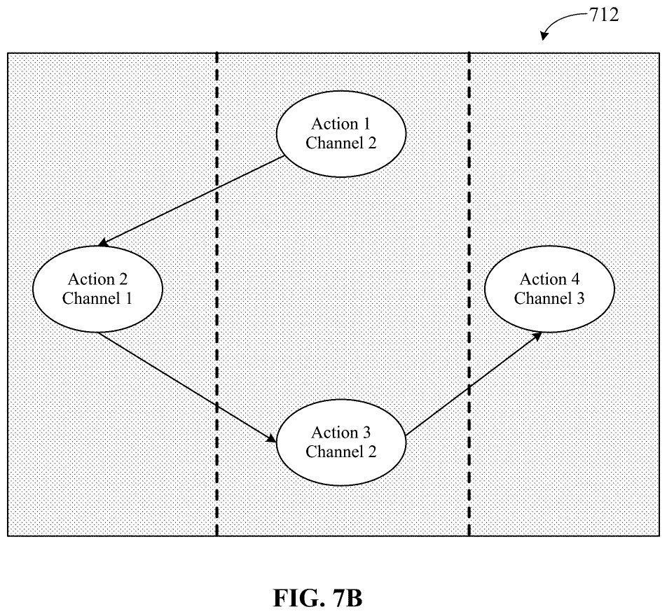

FIGS. 7A and 7B illustrate an example method 700 of generating a schedule of recommended actions based on learning action execution dependencies within a multi-channel environment. Method 700 also may be performed by a system implemented with the example architecture of AALS framework 100 of FIG. 1. In block 702, the system obtains ChatOps contextual information for each action execution. The system, in block 704, generates an action-dependency graph. In block 706, the system clusters each action execution based on the temporal proximities of the execution of each action. The system, in block 708, generates recommendation candidates by ordering the corresponding action executions based on a dependency ordering of the corresponding actions. In block 710, the system ranks the recommendation candidates based on a confidence score associated with each dependency ordering. AALS framework 100 determines the confidence score based on determining a count of the number of co-occurrences of a pair of action executions in a specific order. The confidence scores are normalized by AALS framework 110's dividing each count by the total number of action executions to yield confidence scores lying within the range from zero to one.

FIG. 7B illustrates action-dependency graph 712, showing the dependency ordering of four different actions executed over three separate channels. Illustratively, action 1, which executes in channel 2, precedes action 2, which executes in channel 1. Action 2, for example, may spin up a VM but only after action 1 executes to present a bearer or authentication token. The order of the action executions cannot be swapped. Likewise, action 3 may be prerequisite to action 4, which executes in channel 3. Such dependencies are determined by AALS framework 100 from ChatOps conversations 116.

In certain embodiments, the system anticipates based on the learned schedule of dependencies, when a first action on which a subsequent, second action depends has not occurred at a schedule time. In response to detecting that the first action has not occurred at the scheduled time, in some embodiments, the system automatically responds by initiating execution of the first action such that the second action that depends on the first does not fail.

FIGS. 8A and 8B illustrate examples of the contextual information derived by AALS framework 100 from ChatOps conversations among multiple users utilizing multiple channels of a collaboration platform. In FIG. 8A, ChatOps conversations 800 are illustratively carried over two distinct channels, channels A and B, of the collaboration platform used by five different users, Ajit, Nisha, Ranjit, Rema, and Shekar. The channels are provided on the same collaboration platform but may be for different purposes or relate to different subject matter, requests, and/or computer resources. The contextual information derived by AALS framework 100 for channel A illustratively includes spinning up and later stopping an enterprise resource planning (ERP) system by three different users working on a project during different time shifts. For channel B, the contextual information derived by AALS framework 100 includes three different users providing access to a cluster. AALS framework 100 generates learned schedules over the different channels based on the contextual information. With respect to channel A, autonomous action actuator 112 may automatically generate a command to stop the ERP in response to detecting that the stopping has not been performed in accordance with the learned schedule.

In FIG. 8B, ChatOps conversations 802 are illustratively carried out over a single channel, but involve two different users, a developer and a manager. Action executions corresponding to the ChatOps include the developer's spinning up and stopping the ERP and the managers providing and subsequently revoking access to the cluster. AALS framework 100 can generate separate learned schedules, one for the developer and one for the manager. Autonomous action actuator 112 may automatically generate a command to stop the ERP in response to detecting that the stopping has not been performed in accordance with the developer's learned schedule. Additionally, autonomous action actuator 112 may automatically generate a command to revoke access to the cluster in response to detecting that the manager has failed to revoke access in accordance with the manager's learned schedule.

Various aspects of the present disclosure are described herein by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

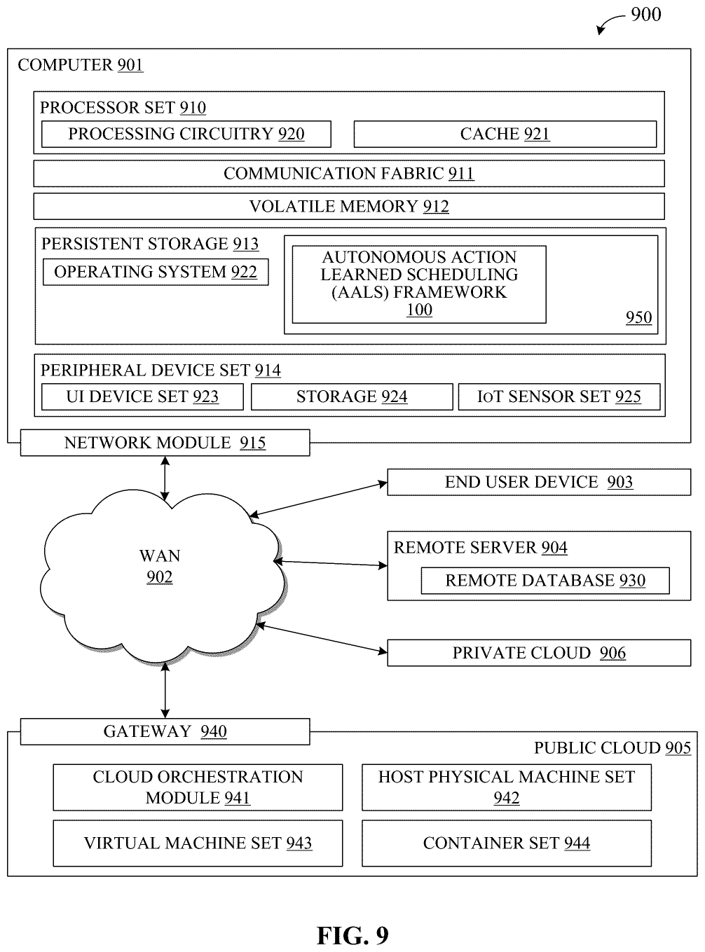

Referring to FIG. 9, computing environment 900 contains an example of an environment for the execution of at least some of the computer code in block 950 involved in performing the inventive methods, such as AALS framework 100 implemented as executable program code or instructions. AALS framework 100 generates one or more learned schedules based on ChatOps associated with a collaboration platform. Learned schedules can be generated for each channel utilized by the collaboration platform and/or for each user utilizing the tools and resources of the collaboration platform.

Computing environment 900 additionally includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and framework AALS 100, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

Computer 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

Processor set 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

Communication fabric 911 perstora is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

Persistent storage 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid-state storage devices. Operating system 922 may take several forms, such as various known proprietary operating systems or open-source Portable Operating System Interface type operating systems that employ a kernel. The code included in block 950 typically includes at least some of the computer code involved in performing the inventive methods.

Peripheral device set 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (e.g., where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

Network module 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (e.g., embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 903 is any computer system that is used and controlled by an end user (e.g., a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

Remote server 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

Public cloud 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The terminology used herein is for the purpose of describing particular embodiments only and is not intended to be limiting. Notwithstanding, several definitions that apply throughout this document will now be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, “real time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating groups of action executions that execute on a collaboration platform, wherein the groups of action executions are generated by natural language processing of contextual information extracted from one or more Chat Operations conversations;
generating recommendation candidates corresponding to the action executions by clustering action executions contained in each of the groups, wherein the clustering is based on times of past executions of the action executions; and
generating a learned schedule by ranking the recommendation candidates based on the contextual information, wherein the learned schedule indicates one or more recommendations to execute a specific action within a specific time.

2. The computer-implemented method of claim 1, wherein the learned schedule is one of multiple learned schedules, and wherein the action executions execute on multiple channels of the collaboration platform, and further comprising:
generating an aggregate ranking of the multiple learned schedules; and
determining, based on the aggregate ranking, an assignment of one or more of the multiple learned schedules to one or more of the multiple channels.

3. The computer-implemented method of claim 1, wherein the learned schedule is one of multiple learned schedules, wherein the contextual information is determined by processing Chat Operations conversations of multiple users of the collaboration platform, and further comprising:
generating an aggregate ranking of the multiple learned schedules; and
determining, based on the aggregate ranking, an assignment of one or more of the multiple learned schedules to one or more of the multiple users.

4. The computer-implemented method of claim 1, wherein the action executions are tail executions, wherein the learned schedule is a schedule of service level agreement (SLA) alerts, and further comprising:
generating an SLA alert in response to detecting a failure to perform a corresponding action.

5. The computer-implemented method of claim 1, wherein the action executions execute on multiple channels of the collaboration platform, and wherein the clustering comprises:
generating a dependency graph based on Chat Operations contextual information for each action execution on each of the multiple channels;
determining a dependency order for each of the action executions in accordance with the clustering based on times of past executions; and
ranking the recommendation candidates based on the dependency order of each action.

6. The computer-implemented method of claim 1, further comprising:
monitoring whether action executions occur at times corresponding to the learned schedule; and
automatically initiating execution of an action in response to determining that a user failed to execute the action in accordance with the learned schedule.

7. The computer-implemented method of claim 1, wherein the generating groups of action executions correlates the one or more Chat Operations conversations with each of the action executions based on identifying a user intent through natural language processing of the one or more Chat Operations conversations.

8. A system, comprising:
one or more processors configured to initiate operations including:
generating groups of action executions that execute on a collaboration platform, wherein the groups of action executions are generated by natural language processing of contextual information extracted from one or more Chat Operations conversations;
generating recommendation candidates corresponding to the action executions by clustering action executions contained in each of the groups, wherein the clustering is based on times of past executions of the action executions; and
generating a leaned schedule by ranking the recommendation candidates based on the contextual information, wherein the learned schedule indicates one or more recommendations to execute a specific action within a specific time.

9. The system of claim 8, wherein the learned schedule is one of multiple learned schedules, wherein the action executions execute on multiple channels of the collaboration platform, and wherein the one or more processors are configured to initiate operations further including:
generating an aggregate ranking of the multiple learned schedules; and
determining, based on the aggregate ranking, an assignment of one or more of the multiple learned schedules to one or more of the multiple channels.

10. The system of claim 8, wherein the learned schedule is one of multiple learned schedules, wherein the contextual information is determined by processing Chat Operations conversations of multiple users of the collaboration platform, and wherein the one or more processors are configured to initiate operations further including:
generating an aggregate ranking of the multiple learned schedules; and
determining, based on the aggregate ranking, an assignment of one or more of the multiple learned schedules to one or more of the multiple users.

11. The system of claim 8, wherein the action executions execute on multiple channels of the collaboration platform, and wherein the clustering comprises:
generating a dependency graph based on Chat Operations contextual information for each action execution on each of the multiple channels;
determining a dependency order for each of the action executions in accordance with the clustering based on times of past executions; and
ranking the recommendation candidates based on the dependency order of each action.

12. The system of claim 8, wherein the one or more processors are configured to initiate operations further including:
monitoring whether action executions occur at times corresponding to the learned schedule; and
automatically initiating execution of an action in response to determining that a user failed to execute the action in accordance with the learned schedule.

13. The system of claim 8, wherein the generating groups of action executions correlates the one or more Chat Operations conversations with each of the action executions based on identifying a user intent through natural language processing of the one or more Chat Operations conversations.

14. A computer program product, the computer program product comprising:
one or more computer-readable storage media and program instructions collectively stored on the one or more computer-readable storage media, the program instructions executable by a processor to cause the processor to initiate operations including:
generating groups of action executions that execute on a collaboration platform, wherein the groups of action executions are generated by natural language processing of contextual information extracted from one or more Chat Operations conversations;
generating recommendation candidates corresponding to the action executions by clustering action executions contained in each of the groups, wherein the clustering is based on times of past executions of the action executions; and
generating a leaned schedule by ranking the recommendation candidates based on the contextual information, wherein the learned schedule indicates one or more recommendations to execute a specific action within a specific time.

15. The computer program product of claim 14, wherein the learned schedule is one of multiple learned schedules, wherein the action executions execute on multiple channels of the collaboration platform, and wherein the program instructions are executable by the processor to cause the processor to initiate operations further including:
generating an aggregate ranking of the multiple learned schedules; and
determining, based on the aggregate ranking, an assignment of one or more of the multiple learned schedules to one or more of the multiple channels.

16. The computer program product of claim 14, wherein the learned schedule is one of multiple learned schedules, wherein the contextual information is determined by processing Chat Operations conversations of multiple users of the collaboration platform, and wherein the program instructions are executable by the processor to cause the processor to initiate operations further including:
generating an aggregate ranking of the multiple learned schedules; and
determining, based on the aggregate ranking, an assignment of one or more of the multiple learned schedules to one or more of the multiple users.

17. The computer program product of claim 14, wherein the action executions are tail executions, wherein the learned schedule is a schedule of service level agreement (SLA) alerts, and wherein the program instructions are executable by the processor to cause the processor to initiate operations further including:
generating an SLA alert in response to detecting a failure to perform a corresponding action.

18. The computer program product of claim 14, wherein the action executions execute on multiple channels of the collaboration platform, and wherein the clustering comprises:
generating a dependency graph based on Chat Operations contextual information for each action execution on each of the multiple channels;
determining a dependency order for each of the action executions in accordance with the clustering based on times of past executions; and
ranking the recommendation candidates based on the dependency order of each action.

19. The computer program product of claim 14, wherein the program instructions are executable by the processor to cause the processor to initiate operations further including:
monitoring whether action executions occur at times corresponding to the learned schedule; and
automatically initiating execution of an action in response to determining that a user failed to execute the action in accordance with the learned schedule.

20. The computer program product of claim 14, wherein the generating groups of action executions correlates the one or more Chat Operations conversations with each of the action executions based on identifying a user intent through natural language processing of the one or more Chat Operations conversations.
